(19) United States
(12) Patent Application Publication
(10) Pub. No.: US 2021/0055116 A1
(43) Pub. Date: Feb. 25, 2021

(54) GET-OFF POINT GUIDANCE METHOD AND VEHICULAR ELECTRONIC DEVICE FOR THE GUIDANCE

(71) Applicant: LG Electronics Inc., Seoul (KR)

(72) Inventor: Soryoung KIM, Seoul (KR)

(21) Appl. No.: 16/997,020

(22) Filed: Aug. 19, 2020

(30) Foreign Application Priority Data
Aug. 19, 2019 (KR) 10-2019-0100812

(51) Int. Cl. G01C 21/34; G08G 1/123; H04W 4/40; G01S 19/01

(52) U.S. Cl. CPC G01C 21/34; G01S 19/01; H04W 4/40; G08G 1/123

(57) ABSTRACT

Disclosed is a vehicular electronic device including a processor configured, upon determining that a vehicle is located within a predetermined distance from an input destination, to acquire passenger information through a camera, to receive, from an external server, information about the type of passenger classified based on the passenger information, to determine one or more get-off points, in consideration of destination information, based on the type of passenger, and to output the one or more get-off points to the passenger through a user interface device. At least one of an autonomous vehicle of the present disclosure, a user terminal, or a server can be linked to or combined with an artificial intelligence module, a drone (unmanned aerial vehicle (UAV)), a robot, an augmented reality (AR) device, a virtual reality (VR) device, a device associated with a 5G service, etc.

### CROSS-REFERENCE TO RELATED APPLICATION

This application claims the benefit of priority to Korean Application No. 10-2019-0100812, filed on Aug. 19, 2019, the contents of which is incorporated by reference in its entirety.

### TECHNICAL FIELD

The present disclosure relates to a get-off point guidance method for a passenger in a vehicle and a vehicular electronic device for the guidance.

### BACKGROUND

A vehicle is an apparatus that carries a user in the direction intended by the user. A car is the main example of such a vehicle. An autonomous vehicle is a vehicle that is capable of traveling autonomously without driving operation by a human.

Currently, a vehicular get-in/get-off guidance service is operated based on GPS coordinates or a wireless local area network such as Radio Frequency Identification (RFID) or ZigBee. However, this method is aimed at indicating the expected arrival time, but does not indicate an exact get-off point.

In the case of autonomous driving, since there is no driving operation by a human, a passenger sets a destination and gets off when arriving at the destination. In this case, conventionally, a passenger sets an exact get-off point through map data, or the point closest to the destination is determined to be the get-off point.

However, this conventional technology sets and determines a get-off point without considering information about the passenger or external factors in the vicinity of the destination when there is a passenger who requires more attention when getting off the vehicle, thus increasing the risk of the occurrence of a secondary accident.

However, in the case of transmitting information about disembarking of all passengers to other vehicles via V2X communication, a lot of vehicles receive the corresponding information, and stop or reduce the speed thereof, thereby slowing the flow of traffic.

### SUMMARY

Therefore, the present disclosure has been made in view of the above problems, and it is an object of the present disclosure to provide a get-off point guidance method for classifying the type of passenger based on information about the passenger and determining a get-off point according to the type of passenger.

It is another object of the present disclosure to provide a get-off point guidance method and a vehicular electronic device for guidance for determining a get-off point in consideration of information about a passenger as well as external factors in the vicinity of the destination.

It is a further object of the present disclosure to provide a get-off point guidance method and a vehicular electronic device for guidance for selecting the situation in which information about scheduled disembarking of a passenger needs to be transmitted via V2X communication.

However, the objects to be accomplished by the disclosure are not limited to the above-mentioned objects, and other objects not mentioned herein will be clearly understood by those skilled in the art from the following description.

In accordance with an aspect of the present disclosure, the above objects can be accomplished by the provision of a get-off point guidance method including acquiring, by a processor, passenger information through a camera, classifying, by an external server, the type of passenger based on the passenger information, determining, by the processor, one or more get-off points based on the type of passenger, and indicating, by the processor, the one or more get-off points to the passenger.

The get-off point guidance method according to the embodiment of the present disclosure can further include receiving, by the external server, the passenger information from the processor, determining a first speed, the first speed being a speed at which the passenger gets off the vehicle, a second speed, the second speed being a speed at which the passenger moves after getting off the vehicle, and a third speed, the third speed being a speed at which the passenger responds to an emergency situation, based on the passenger information, and classifying the type of passenger as one of a first type, a second type, and a third type based on the first speed, the second speed, and the third speed.

The get-off point guidance method according to the embodiment of the present disclosure can further include, when the first speed, the second speed, and the third speed, determined based on the passenger information, are within respective predetermined ranges, classifying, by the external server, the type of passenger as the first type.

The get-off point guidance method according to the embodiment of the present disclosure can further include, when any one of the first speed, the second speed, and the third speed, determined based on the passenger information, is within a predetermined range or when any one of the first speed, the second speed, and the third speed, determined based on the passenger information, is out of a predetermined range, classifying, by the external server, the type of passenger as the second type.

The get-off point guidance method according to the embodiment of the present disclosure can further include, when the first speed, the second speed, and the third speed, determined based on the passenger information, are out of respective predetermined ranges, classifying, by the external server, the type of passenger as the third type.

The get-off point guidance method according to the embodiment of the present disclosure can include determining a first get-off point based on the passenger type information and/or the destination information, the first get-off point being an appropriate get-off point, and determining a second get-off point, the second get-off point being a get-off point of another passenger who is of the same type as the type of passenger.

The determining a first get-off point according to the embodiment of the present disclosure can further include receiving the passenger type information from the external server, and receiving the destination information through an interface unit.

The determining a second get-off point according to the embodiment of the present disclosure can further include receiving disembarking information of another passenger, who is of the same type as the type of passenger, from the external server.

In the get-off point guidance method according to the embodiment of the present disclosure, the determining the get-off point can further include, upon determining, by the processor, that neither the first get-off point nor the second get-off point exists, generating a third get-off point based on information about traffic in the vicinity of the destination, the third get-off point being a new get-off point.

The get-off point guidance method according to the embodiment of the present disclosure can include outputting information about locations of the one or more get-off points through a user interface device, and determining one final get-off point among the one or more get-off points based on a signal input by the passenger.

The get-off point guidance method according to the embodiment of the present disclosure can further include, upon determining that the third get-off point is the final get-off point, transmitting information about scheduled disembarking of the passenger to vehicles in the vicinity of the third get-off point via V2X communication.

The get-off point guidance method according to the embodiment of the present disclosure can further include determining, by the processor, whether the passenger finished getting off the vehicle, upon determining that the passenger finished getting off the vehicle, transmitting, by the processor, disembarking information of the passenger to the external server, and storing, by the external server, the disembarking information of the passenger.

In accordance with another aspect of the present disclosure, there is provided a vehicular electronic device including a processor configured, upon determining that a vehicle is located within a predetermined distance from an input destination, to acquire passenger information through a camera, to receive, from an external server, information about the type of passenger classified based on the passenger information, to determine one or more get-off points, in consideration of destination information, based on the type of passenger, and to output the one or more get-off points to the passenger through a user interface device.

The vehicular electronic device according to the embodiment of the present disclosure can include a processor configured to determine one final get-off point among the one or more get-off points based on a signal input by the passenger and to generate a route based on the final get-off point.

The vehicular electronic device according to the embodiment of the present disclosure can include a processor configured, upon determining that the passenger finished getting off the vehicle at the final get-off point, to transmit disembarking information of the passenger to the external server.

Details of other embodiments are included in the detailed description and the accompanying drawings.

According to the present disclosure, there are one or more effects as follows.

First, the type of passenger can be classified according to passenger information, and a get-off point can be determined according to the type of passenger, thus making it possible to improve the safety of a passenger who requires attention while getting off the vehicle.

Second, a get-off point can be determined in consideration of information about the surroundings of a destination as well as passenger information, thus determining a get-off point that is safer and improving passenger satisfaction with a get-off point guidance service.

Third, only when neither a first get-off point nor a second get-off point exists, information about a third get-off point is transmitted to other vehicles in advance via V2X communication, thus making it possible to secure the driving efficiency of the other vehicles and to reduce the wasteful use of resources of the host vehicle.

Fourth, the reliability of information can be enhanced through sharing of passenger disembarking information.

However, the effects achievable through the disclosure are not limited to the above-mentioned effects, and other effects not mentioned herein will be clearly understood by those skilled in the art from the appended claims.

### BRIEF DESCRIPTION OF THE DRAWINGS

FIG. 1 is a view showing the external appearance of a vehicle according to an embodiment of the present disclosure.

FIG. 2 is a view showing the interior of the vehicle according to the embodiment of the present disclosure.

FIG. 3 is a control block diagram of the vehicle according to the embodiment of the present disclosure.

FIG. 4 is a control block diagram of an electronic device according to an embodiment of the present disclosure.

FIG. 5 is a flowchart of a guidance method according to an embodiment of the present disclosure.

FIG. 6 is a flowchart of a step of classifying the type of passenger according to an embodiment of the present disclosure.

FIG. 7 is a flowchart of a step of determining a get-off point according to an embodiment of the present disclosure.

FIG. 8 is a view showing a get-off point guidance UI according to an embodiment of the present disclosure.

FIG. 9 is a flowchart of a processor according to an embodiment of the present disclosure.

FIG. 10 is a diagram showing a get-off point guidance system according to an embodiment of the present disclosure.

FIG. 11 illustrates an example of basic operation of an autonomous vehicle and a 5G network in a 5G communication system.

FIG. 12 illustrates an example of application operation of the autonomous vehicle and the 5G network in the 5G communication system.

FIGS. 13 to 16 illustrate an example of the operation of the autonomous vehicle using the 5G communication.

### DETAILED DESCRIPTION

Reference will now be made in detail to the preferred embodiments of the present disclosure, examples of which are illustrated in the accompanying drawings. Wherever possible, the same reference numbers will be used throughout the drawings to refer to the same or like parts. As used herein, the suffixes “module” and “unit” are added or interchangeably used to facilitate preparation of this specification and are not intended to suggest unique meanings or functions. In describing embodiments disclosed in this specification, a detailed description of relevant well-known technologies cannot be given in order not to obscure the subject matter of the present disclosure. In addition, the accompanying drawings are merely intended to facilitate understanding of the embodiments disclosed in this specification and not to restrict the technical spirit of the present disclosure. In addition, the accompanying drawings should be understood as covering all equivalents or substitutions within the scope of the present disclosure.

Terms including ordinal numbers such as first, second, etc. can be used to explain various elements. However, it will be appreciated that the elements are not limited to such terms. These terms are merely used to distinguish one element from another.

It will be understood that when an element is referred to as being “connected” or “coupled” to another element, it can be directly connected or coupled to another element or intervening elements can be present. In contrast, when an element is referred to as being “directly connected” or “directly coupled” to another element, there are no intervening elements present.

The expression of singularity includes a plural meaning unless the singularity expression is explicitly different in context.

It will be further understood that terms such as “include” or “have”, when used in this specification, specify the presence of stated features, integers, steps, operations, elements, components, or combinations thereof, but do not preclude the presence or addition of one or more other features, integers, steps, operations, elements, components, or combinations thereof.

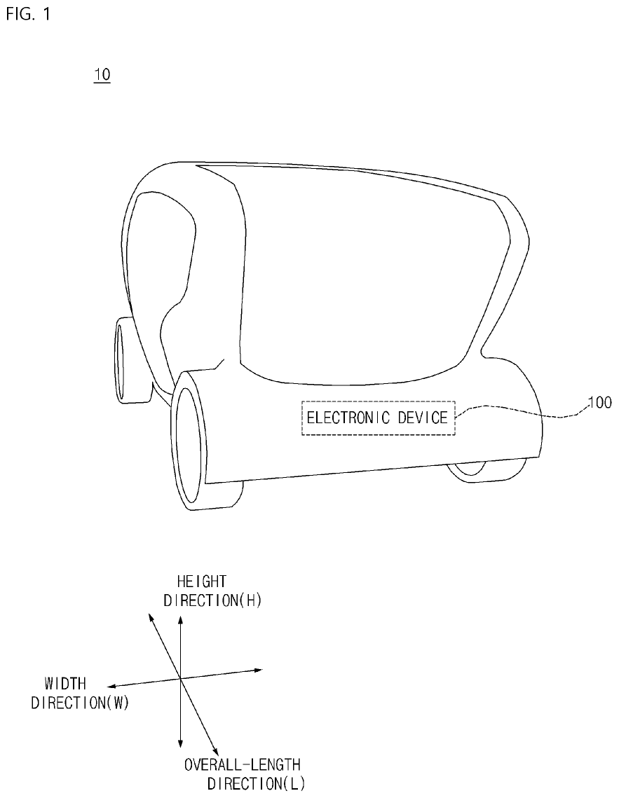

FIG. 1 is a view showing a vehicle according to an embodiment of the present disclosure.

Referring to FIG. 1, a vehicle 10 according to an embodiment of the present disclosure is defined as a transportation means that travels on a road or on rails. The vehicle 10 conceptually encompasses cars, trains, and motorcycles. The vehicle 10 can be any of an internal combustion vehicle equipped with an engine as a power source, a hybrid vehicle equipped with an engine and an electric motor as power sources, an electric vehicle equipped with an electric motor as a power source, and the like. The vehicle 10 can be a shared vehicle. The vehicle 10 can be an autonomous vehicle.

The vehicle 10 can include an electronic device 100. The electronic device 100 can be a device for performing get-off point guidance when a passenger gets off the vehicle 10.

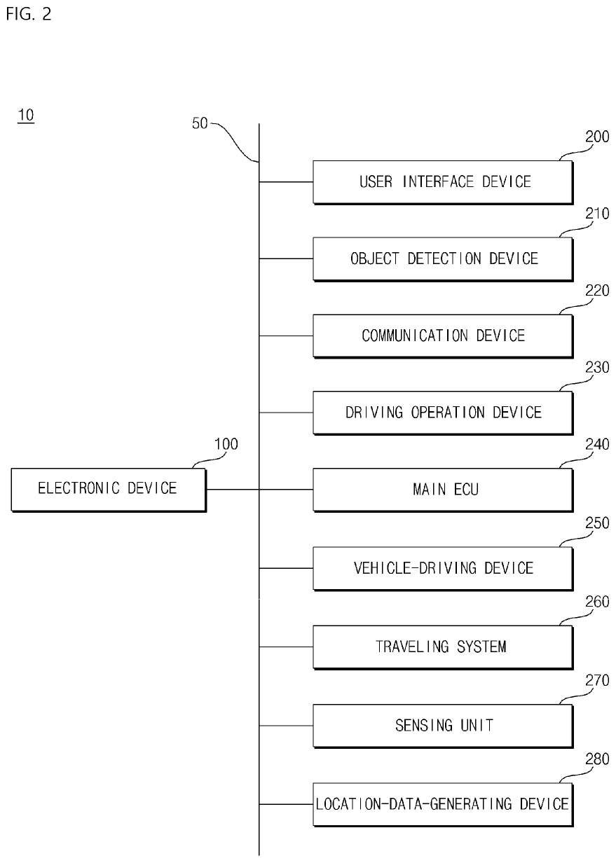

FIG. 2 is a view showing the interior of the vehicle according to the embodiment of the present disclosure.

Referring to FIG. 2, the vehicle 10 can include a camera 130 mounted therein. The camera 130 can be mounted inside the vehicle 10 and can capture an image of a passenger. In this case, a driver status monitoring (DSM) system can be used.

The DSM system is a system that senses the state of a driver and controls the vehicle 10 according to the state of the driver. The DSM system can include an input device such as an internal camera or a microphone. The DSM system can sense the state of the driver, such as whether the driver is looking ahead, whether the driver is dozing, whether the driver is eating food, whether the driver is operating a device, or the like.

In one embodiment according to the present disclosure, the DSM system can sense the state of a passenger as well as the state of the driver through a plurality of cameras 130 mounted inside the vehicle.

For example, the DSM system can analyze an image of the passenger acquired by the internal camera 130 and can generate information about whether the passenger is using a mobility assistance device based on the information about the state of the passenger.

For example, the DSM system can analyze an image of the passenger acquired by the internal camera 130 and can generate information about whether the passenger is operating a device such as a portable device.

In addition, the DSM system can analyze an image of the passenger acquired by the internal camera 130 and can generate information about the age of the passenger.

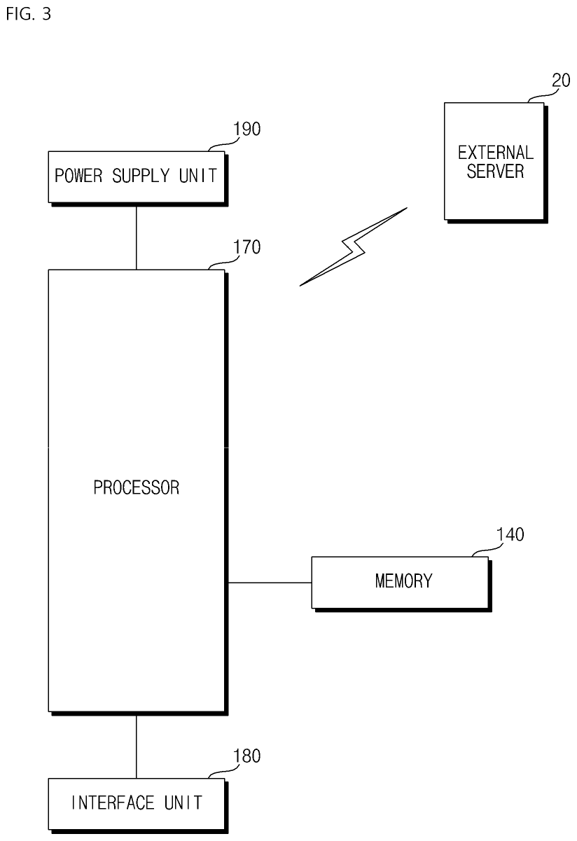

Although not shown in the drawings, the vehicle 10 can include a camera 130 mounted on the exterior thereof. The external camera 130 can capture an image of the passenger, in which information about the body of the passenger is included. In this case, an object detection device 210 can be used. The object detection device 210 will be described later with reference to FIG. 3.

The vehicle 10 can acquire passenger information, which includes information about the age of the passenger and information about the state of the passenger, from an image of the passenger, which is captured by the camera 130 mounted inside or outside the vehicle and includes information about the body of the passenger.

FIG. 3 is a control block diagram of the vehicle according to the embodiment of the present disclosure.

Referring to FIG. 3, the vehicle 10 can include a vehicular electronic device 100, a user interface device 200, an object detection device 210, a communication device 220, a driving operation device 230, a main ECU 240, a vehicle-driving device 250, a traveling system 260, a sensing unit 270, and a location-data-generating device 280.

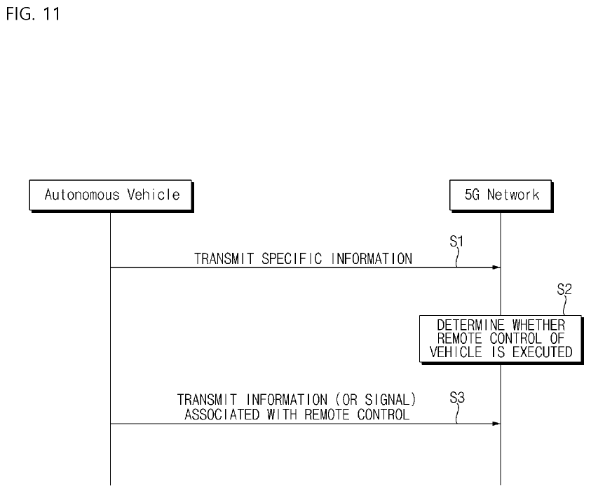

The electronic device 100 can perform a get-off point guidance operation for the passenger. The electronic device 100 can exchange information about the passenger, information about the type of passenger, information about disembarking of the passenger, and the like with an external server 20 using the communication device 220 in the vehicle 10, thereby performing the get-off point guidance operation for the passenger. In this case, a 5G communication system can be used. An operation method of an autonomous vehicle and a 5G network in the 5G communication system will be described later with reference to FIGS. 11 to 16.

The electronic device 100 can perform the get-off point guidance operation for the passenger by indicating a get-off point to the passenger using the user interface device 200 in the vehicle 10. In this case, a microphone, a speaker, and a display provided in the vehicle 10 can be used. The microphone, the speaker, and the display provided in the vehicle 10 can be lower-level components of the user interface device 200.

The user interface device 200 is a device used to enable the vehicle 10 to communicate with a user. The user interface device 200 can receive user input and can provide information generated by the vehicle 10 to the user. The vehicle 10 can implement a User Interface (UI) or a User Experience (UX) through the user interface device 200.

The user interface device 200 can include an input unit and an output unit.

The input unit is used to receive information from a user. Data collected by the input unit can be processed as a control command of the user. The input unit can include a voice input unit, a gesture input unit, a touch input unit, and a mechanical input unit.

The output unit is used to generate a visual output, an acoustic output, or a haptic output. The output unit can include at least one of a display unit, an audio output unit, or a haptic output unit.

The display unit can display graphic objects corresponding to various pieces of information. The display unit can include at least one of a Liquid Crystal Display (LCD), a Thin Film Transistor-LCD (TFT LCD), an Organic Light-Emitting Diode (OLED) display, a flexible display, a three-dimensional (3D) display, or an e-ink display.

The display unit can be implemented as a touch screen by forming a multi-layered structure with the touch input unit or by being integrated with the touch input unit. The display unit can be configured as a Head Up Display (HUD). In this case, the display unit can be provided with a projection module, and can output information through an image projected onto the windshield or the window.

The display unit can be disposed in a portion of the steering wheel, a portion of the instrument panel, a portion of the seat, a portion of the pillar, a portion of the door, a portion of the center console, a portion of the head lining, or a portion of the sun visor, or can be implemented in a portion of the windshield or a portion of the window.

Meanwhile, the user interface device 200 can include a plurality of display units.

The audio output unit converts an electrical signal received from the processor 170 into an audio signal and outputs the audio signal. To this end, the audio output unit can include one or more speakers.

The haptic output unit generates a haptic output. For example, the haptic output unit can vibrate the steering wheel, the safety belt, or the seats, so that a user perceives the output.

Meanwhile, the user interface device 200 can be referred to as a display device for a vehicle.

The object detection device 210 can include at least one sensor capable of detecting objects outside the vehicle 10. The object detection device 210 can include at least one of a camera, a radar, a lidar, an ultrasonic sensor, or an infrared sensor. The object detection device 210 can provide data on an object, generated based on a sensing signal generated by the sensor, to at least one electronic device included in the vehicle.

The objects can be various items related to driving of the vehicle 10. For example, the objects can include a lane, another vehicle, a pedestrian, a 2-wheeled vehicle, a traffic signal, a light, a road, a structure, a speed bump, a geographic feature, an animal, and so on.

Meanwhile, the objects can be classified into mobile objects and fixed objects. For example, mobile objects can conceptually include another vehicle and a pedestrian, and fixed objects can conceptually include a traffic signal, a road, and a structure.

The camera 130 can generate information about objects outside the vehicle 10 using an image. The camera 130 can include at least one lens, at least one image sensor, and at least one processor, which is electrically connected to the image sensor, processes a received signal, and generates data on an object based on the processed signal.

The camera 130 can be at least one of a mono camera, a stereo camera, or an Around View Monitoring (AVM) camera. The camera 310 can acquire information about the location of an object, information about the distance to an object, or information about the relative speed with respect to an object using any of various image-processing algorithms. For example, the camera 130 can acquire information about the distance to the object and information about the relative speed with respect to the object in the acquired image based on variation in the size of the object over time.

For example, the camera 130 can acquire information about the distance to the object and information about the relative speed with respect to the object through a pin hole model, road surface profiling, or the like.

For example, the camera 130 can acquire information about the distance to the object and information about the relative speed with respect to the object based on disparity information in a stereo image acquired by the stereo camera.

In the embodiment of the present disclosure, the camera 130 can capture an image of a passenger who desires to get in the vehicle 10, and can acquire information about the state of the passenger from the image of the passenger. The information about the state of the passenger can include information about whether the passenger is pregnant, whether the passenger is using a mobility assistance device, whether the passenger is carrying baggage, whether the passenger is using a terminal, or the like.

The radar can generate information about objects outside the vehicle 10 using an electronic wave. The radar can include an electromagnetic wave transmitter, an electromagnetic wave receiver, and at least one processor, which is electrically connected to the electromagnetic wave transmitter and the electromagnetic wave receiver, processes a received signal, and generates data on an object based on the processed signal.

The radar can be embodied as pulse radar or continuous wave radar depending on the principle by which an electronic wave is emitted. The radar can be embodied as Frequency Modulated Continuous Wave (FMCW)-type radar or Frequency Shift Keying (FSK)-type radar as a continuous wave radar scheme according to a signal waveform. The radar can detect an object using an electromagnetic wave based on a Time-of-Flight (ToF) scheme or a phase-shift scheme, and can detect the location of the detected object, the distance to the detected object, and the relative speed with respect to the detected object.

The lidar can generate information about objects outside the vehicle 10 using a laser beam. The lidar can include an optical transmitter, an optical receiver, and at least one processor, which is electrically connected to the optical transmitter and the optical receiver, processes a received signal, and generates data on an object based on the processed signal.

The lidar can be implemented in a ToF scheme or a phase-shift scheme. The lidar can be implemented in a driven or non-driven manner. When the lidar is implemented in a driven manner, the lidar can be rotated by a motor and can detect objects around the vehicle 10. When the lidar is implemented in a non-driven manner, the lidar can detect objects located within a predetermined range from the vehicle through optical steering.

The vehicle 10 can include a plurality of non-driven-type lidars. The lidar can detect an object using laser light based on a ToF scheme or a phase-shift scheme, and can detect the location of the detected object, the distance to the detected object, and the relative speed with respect to the detected object.

The communication device 220 can exchange a signal with a device located outside the vehicle 10. The communication device 220 can exchange a signal with at least one of infrastructure (e.g. a server or a broadcasting station) or other vehicles. The communication device 220 can include at least one of a transmission antenna, a reception antenna, a radio frequency (RF) circuit capable of realizing various communication protocols, or an RF element in order to perform communication.

The communication device 220 can include a short-range communication unit, a location information unit, a V2X communication unit, an optical communication unit, a broadcasting transceiver unit, and an Intelligent Transport System (ITS) communication unit.

The V2X communication unit is a unit used for wireless communication with a server (Vehicle to Infrastructure (V2I)), another vehicle (Vehicle to Vehicle (V2V)), or a pedestrian (Vehicle to Pedestrian (V2P)). The V2X communication unit can include an RF circuit capable of implementing a V2I protocol, a V2V protocol, and a V2P protocol.

Meanwhile, the communication device 220 can implement a display device for a vehicle together with the user interface device 200. In this case, the display device for a vehicle can be referred to as a telematics device or an Audio Video Navigation (AVN) device.

The communication device 220 can communicate with a device outside the vehicle 10 using a 5G (e.g. a new radio (NR)) scheme. The communication device 220 can implement V2X (V2V, V2D, V2P, or V2N) communication using a 5G scheme.

The driving operation device 230 is a device that receives user input for driving the vehicle. In the manual mode, the vehicle 10 can be driven based on a signal provided by the driving operation device 230. The driving operation device 230 can include a steering input device (e.g. a steering wheel), an acceleration input device (e.g. an accelerator pedal), and a brake input device (e.g. a brake pedal).

The main ECU 240 can control the overall operation of at least one electronic device provided in the vehicle 10.

The driving control device 250 is a device that electrically controls various vehicle-driving devices provided in the vehicle 10. The driving control device 250 can include a powertrain driving controller, a chassis driving controller, a door/window driving controller, a safety device driving controller, a lamp driving controller, and an air-conditioner driving controller. The powertrain driving controller can include a power source driving controller and a transmission driving controller. The chassis driving controller can include a steering driving controller, a brake driving controller, and a suspension driving controller.

Meanwhile, the safety device driving controller can include a safety belt driving controller for controlling the safety belt.

The vehicle driving control device 250 can be referred to as a control electronic control unit (a control ECU).

The traveling system 260 can generate a signal for controlling the movement of the vehicle 10 or outputting information to the user based on the data on an object received from the object detection device 210. The traveling system 260 can provide the generated signal to at least one of the user interface device 200, the main ECU 240, or the vehicle-driving device 250.

The traveling system 260 can conceptually include an Advanced Driver Assistance System (ADAS). The ADAS 260 can implement at least one of Adaptive Cruise Control (ACC), Autonomous Emergency Braking (AEB), Forward Collision Warning (FCW), Lane Keeping Assist (LKA), Lane Change Assist (LCA), Target Following Assist (TFA), Blind Spot Detection (BSD), High Beam Assist (HBA), Auto Parking System (APS), PD collision warning system, Traffic Sign Recognition (TSR), Traffic Sign Assist (TSA), Night Vision (NV), Driver Status Monitoring (DSM), or Traffic Jam Assist (TJA).

The traveling system 260 can include an autonomous-driving electronic control unit (an autonomous-driving ECU). The autonomous-driving ECU can set an autonomous-driving route based on data received from at least one of the other electronic devices provided in the vehicle 10. The autonomous-driving ECU can set an autonomous-driving route based on data received from at least one of the user interface device 200, the object detection device 210, the communication device 220, the sensing unit 270, or the location-data-generating device 280. The autonomous-driving ECU can generate a control signal so that the vehicle 10 travels along the autonomous-driving route. The control signal generated by the autonomous-driving ECU can be provided to at least one of the main ECU 240 or the vehicle-driving device 250.

The sensing unit 270 can sense the state of the vehicle. The sensing unit 270 can include at least one of an inertial measurement unit (IMU) sensor, a collision sensor, a wheel sensor, a speed sensor, an inclination sensor, a weight detection sensor, a heading sensor, a position module, a vehicle forward/reverse movement sensor, a battery sensor, a fuel sensor, a tire sensor, a steering sensor for detecting rotation of the steering wheel, a vehicle internal temperature sensor, a vehicle internal humidity sensor, an ultrasonic sensor, an illuminance sensor, an accelerator pedal position sensor, or a brake pedal position sensor. Meanwhile, the inertial measurement unit (IMU) sensor can include at least one of an acceleration sensor, a gyro sensor, or a magnetic sensor.

The sensing unit 270 can generate data on the state of the vehicle based on the signal generated by at least one sensor. The sensing unit 270 can acquire sensing signals of vehicle orientation information, vehicle motion information, vehicle yaw information, vehicle roll information, vehicle pitch information, vehicle collision information, vehicle heading information, vehicle angle information, vehicle speed information, vehicle acceleration information, vehicle inclination information, vehicle forward/reverse movement information, battery information, fuel information, tire information, vehicle lamp information, vehicle internal temperature information, vehicle internal humidity information, a steering wheel rotation angle, vehicle external illuminance, the pressure applied to the accelerator pedal, the pressure applied to the brake pedal, and so on.

The sensing unit 270 can further include an accelerator pedal sensor, a pressure sensor, an engine speed sensor, an air flow sensor (AFS), an air temperature sensor (ATS), a water temperature sensor (WTS), a throttle position sensor (TPS), a top dead center (TDC) sensor, a crank angle sensor (CAS), and so on.

The sensing unit 270 can generate vehicle state information based on the sensing data. The vehicle state information can be generated based on data detected by various sensors provided in the vehicle.

For example, the vehicle state information can include vehicle orientation information, vehicle speed information, vehicle inclination information, vehicle weight information, vehicle heading information, vehicle battery information, vehicle fuel information, vehicle tire air pressure information, vehicle steering information, vehicle internal temperature information, vehicle internal humidity information, pedal position information, vehicle engine temperature information, and so on.

Meanwhile, the sensing unit can include a tension sensor. The tension sensor can generate a sensing signal based on the tension state of the safety belt.

The location-data-generating device 280 can generate data on the location of the vehicle 10. The location-data-generating device 280 can include at least one of a global positioning system (GPS) or a differential global positioning system (DGPS). The location-data-generating device 280 can generate data on the location of the vehicle 10 based on the signal generated by at least one of the GPS or the DGPS. In some embodiments, the location-data-generating device 280 can correct the location data based on at least one of the inertial measurement unit (IMU) of the sensing unit 270 or the camera of the object detection device 210.

The location-data-generating device 280 can be referred to as a location positioning device. The location-data-generating device 280 can be referred to as a global navigation satellite system (GNSS).

The vehicle 10 can include an internal communication system 50. The electronic devices included in the vehicle 10 can exchange a signal via the internal communication system 50. The signal can include data. The internal communication system 50 can use at least one communication protocol (e.g. CAN, LIN, FlexRay, MOST, and Ethernet).

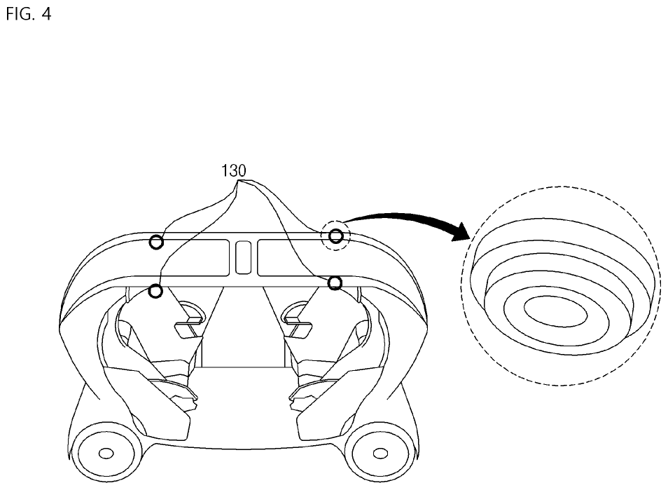

FIG. 4 is a control block diagram of the electronic device according to the embodiment of the present disclosure.

Referring to FIG. 4, the electronic device 100 can include a memory 140, a processor 170, an interface unit 180, and a power supply unit 190.

The memory 140 is electrically connected to the processor 170. The memory 140 can store basic data about the units, control data necessary to control the operation of the units, and data that are input and output. The memory 140 can store data processed by the processor 170. In a hardware aspect, the memory 140 can be constituted by at least one of a ROM, a RAM, an EPROM, a flash drive, or a hard drive. The memory 140 can store various data necessary to perform the overall operation of the electronic device 100, such as a program for processing or control of the processor 170. The memory 140 can be integrated with the processor 170. In some embodiments, the memory 140 can be configured as a lower-level component of the processor 170.

The interface unit 180 can exchange a signal with at least one electronic device provided in the vehicle 10 in a wired or wireless manner. The interface unit 180 can exchange a signal with at least one of the object detection device 210, the communication device 220, the driving operation device 230, the main ECU 240, the vehicle-driving device 250, the ADAS 260, the sensing unit 270, or the location-data-generating device 280 in a wired or wireless manner.

The interface unit 180 can be constituted by at least one of a communication module, a terminal, a pin, a cable, a port, a circuit, an element, or a device.

The interface unit 180 can receive location data of the vehicle 10 from the location-data-generating device 280. The interface unit 180 can receive driving speed data from the sensing unit 270. The interface unit 180 can receive data on objects around the vehicle from the object detection device 210. The interface unit 180 can exchange data with the external server 20 through the communication device 220.

The power supply unit 190 can supply power to the electronic device 100. The power supply unit 190 can receive power from a power source (e.g. a battery) included in the vehicle 10, and can supply the power to the respective units of the electronic device 100. The power supply unit 190 can be operated according to a control signal provided from the main ECU 240. The power supply unit 190 can be configured as a switched-mode power supply (SMPS).

The processor 170 can be electrically connected to the memory 140, the interface unit 180, and the power supply unit 190, and can exchange a signal therewith. The processor 170 can be configured using at least one of application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, or electrical units for performing other functions.

The processor 170 can be driven by the power supplied from the power supply unit 190. The processor 170 can receive data, process data, generate a signal, and provide a signal while receiving the power from the power supply unit 190.

The processor 170 can receive information from the other electronic devices in the vehicle 10 through the interface unit 180. The processor 170 can provide a control signal to the other electronic devices in the vehicle 10 through the interface unit 180.

Upon determining that the vehicle is located within a predetermined distance from the input destination, the processor 170 can acquire passenger information through the camera, can receive passenger type information classified based on the passenger information from the external server, can determine one or more get-off points, in consideration of destination information, based on the type of passenger, and can output the one or more get-off points through the user interface device 200.

The processor 170 can receive destination information from the user interface device 200 in the vehicle through the interface unit 180. The processor 170 can receive vehicle location information from the location-data-generating device 280 through the interface unit 180. The processor 170 can determine whether the vehicle is located in the vicinity of the destination based on the received location information. The processor 170 can determine whether the vehicle is located within a predetermined distance from the destination.

Upon determining that the vehicle is located within a predetermined distance from the destination, the processor 170 can acquire passenger information through the camera. The processor 170 can transmit the acquired passenger information to the external server 20. The passenger information can include passenger age information and passenger state information.

The passenger state information can include information about the state of the passenger, which can be identified from an image of the external appearance of the passenger that is acquired through the camera, for example, information about whether the passenger is pregnant, whether the passenger is using a mobility assistance device, whether the passenger is using a mobile terminal, whether the passenger is carrying baggage, or the like. In this case, an artificial-intelligence learning model can be used.

The processor 170 can receive passenger type information classified based on the passenger information from the external server 20. The processor 170 can determine one or more get-off points in consideration of destination information, based on the passenger type information. The processor 170 can output the one or more get-off points to the passenger through the user interface device 200.

The passenger type information can include the type of passenger, which is classified based on a first speed, which is the speed at which the passenger gets off the vehicle, a second speed, which is the speed at which the passenger moves after getting off the vehicle, and a third speed, which is the speed at which the passenger responds to an emergency situation, first speed information, second speed information, and third speed information. The type of passenger can be any one of a first type, a second type, and a third type.

The processor 170 can determine a first get-off point, which is an appropriate get-off point based on the passenger type information and/or the destination information. The destination information can include road condition information, traffic condition information, information about objects in the vicinity of the destination, weather information, and the like. The processor 170 can detect the destination information through the object detection device 210. The processor 170 can exchange the destination information with a device located outside the vehicle 10 through the communication device 220.

The processor 170 can determine a second get-off point, which is a get-off point of another passenger, who is of the same type as the passenger. The processor 170 can receive information about a get-off point of another passenger from the external server 20, and can determine a second get-off point.

Upon determining that neither the first get-off point nor the second get-off point exists, the processor 170 can generate a third get-off point, which is a new get-off point, based on information about traffic in the vicinity of the destination. The processor 170 can detect information about traffic in the vicinity of the destination through the object detection device 210. The processor 170 can exchange the information about traffic in the vicinity of the destination with a device located outside the vehicle 10 through the communication device 220.

The processor 170 can determine a final get-off point among one or more get-off points based on a signal input by the passenger. The processor 170 can receive an input signal regarding the determination as to a final get-off point from the passenger through the user interface device 200.

The processor 170 can generate a route based on the final get-off point. The processor 170 can control driving of the vehicle based on the generated route. The processor 170 can control the vehicle-driving control device 250, such as a steering control device, a braking control device, or an acceleration control device, in order to control driving of the vehicle such that the vehicle travels along the generated route.

If the final get-off point is the third get-off point, the processor 170 can transmit information about the scheduled disembarking of the passenger to other vehicles around the third get-off point via V2X communication. The information about the scheduled disembarking of the passenger can include passenger type information, get-off location information, get-off time information, and the like.

Upon determining that the passenger finished getting off the vehicle at the final get-off point, the processor 170 can transmit the passenger disembarking information to the external server 20. The passenger disembarking information can include information about the location of the get-off point at which the passenger finished getting off the vehicle, information about the time at which the passenger finished getting off the vehicle, passenger type information, and information about whether the passenger got out of the vehicle safely.

The processor 170 can receive user input through the user interface device. For example, the processor 170 can receive at least one of voice input, gesture input, touch input, or mechanical input through the user interface device 200.

The electronic device 100 can include at least one printed circuit board (PCB). The memory 140, the interface unit 180, the power supply unit 190, and the processor 170 can be electrically connected to the printed circuit board.

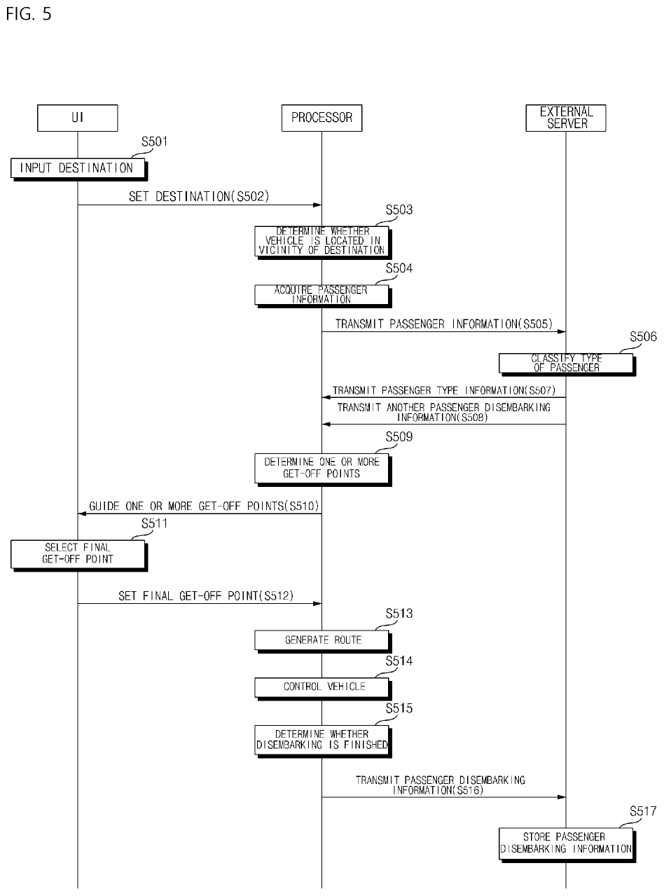

FIG. 5 is a flowchart of a guidance method according to an embodiment of the present disclosure.

Referring to FIG. 5, the get-off point guidance for the passenger can be performed through communication among the user interface device 200, the processor 170, and the external server 20.

A user can input a destination through the user interface device 200 (S501). The processor 170 can receive a destination input signal and can set a destination (S502).

The processor 170 can receive destination information and vehicle location information through the interface unit 180. The processor 170 can determine whether the vehicle is located in the vicinity of the destination based on the received location information (S503). The processor 170 can determine whether the vehicle is located within a predetermined distance from the destination.

Upon determining that the vehicle is located within a predetermined distance from the destination, the processor 170 can acquire passenger information through the camera (S504). The processor 170 can transmit the acquired passenger information to the external server 20 (S505). The passenger information can include passenger age information and passenger state information.

The external server 20 can classify the type of passenger based on the passenger information (S506). The external server 20 can classify the type of passenger based on a first speed, which is the speed at which the passenger gets off the vehicle, a second speed, which is the speed at which the passenger moves after getting off the vehicle, and a third speed, which is the speed at which the passenger responds to an emergency situation. The type of passenger can be any one of a first type, a second type, and a third type.

The external server 20 can determine whether the first speed, the second speed, and the third speed are within respective predetermined ranges based on the passenger information.

When all of the first speed, the second speed, and the third speed are within respective predetermined ranges, the external server 20 can classify the type of passenger as the first type. When any one of the first speed, the second speed, and the third speed is within a predetermined range or when any one of the first speed, the second speed, and the third speed is out of a predetermined range, the external server 20 can classify the type of passenger as the second type. When all of the first speed, the second speed, and the third speed are out of respective predetermined ranges, the external server 20 can classify the type of passenger as the third type.

The external server 20 can transmit passenger type information classified based on the passenger information to the processor 170 (S507).

The external server 20 can transmit information about disembarking of another passenger to the processor 170 (S508). The other passenger information can be of the same type as the passenger type information classified by the external server 20 based on the passenger information.

The processor 170 can determine one or more get-off points, in consideration of destination information, based on the type of passenger (S509). The one or more get-off points can include a first get-off point, a second get-off point, and a third get-off point.

The processor 170 can determine a first get-off point, which is an appropriate get-off point based on the passenger type information and/or the destination information. The processor 170 can determine a second get-off point, which is a get-off point of another passenger who is of the same type as the passenger.

Upon determining that neither the first get-off point nor the second get-off point exists, the processor 170 can generate a third get-off point, which is a new get-off point, based on information about traffic in the vicinity of the destination.

The processor 170 can indicate one or more get-off points to the passenger through the user interface device 200 (S510). The user can select one final get-off point from among one or more get-off points through the user interface device 200 (S511).

Guidance of one or more get-off points can include outputting information about the locations of one or more get-off points through the user interface device 200. Specifically, different icons, each representing a corresponding one of the first get-off point, the second get-off point, and the third get-off point, can be displayed at corresponding locations. If the third get-off point is the final get-off point, information about the scheduled disembarking of the passenger can be transmitted to other vehicles around the third get-off point via V2X communication.

The user interface device 200 can transmit an input signal regarding selection of a final get-off point by the passenger to the processor 170, and can set a final get-off point (S512). The processor 170 can determine one final get-off point among one or more get-off points based on a signal input by the passenger.

The processor 170 can generate a route based on the final get-off point (S513). The processor 170 can control driving of the vehicle based on the generated route (S514). The processor 170 can control the vehicle-driving control device 250, such as a steering control device, a braking control device, or an acceleration control device, in order to control driving of the vehicle such that the vehicle travels along the generated route.

The processor 170 can determine whether the passenger finished getting off the vehicle at the final get-off point through the internal or external camera 130 of the vehicle 10 (S515). The processor 170 can determine that the disembarking of the passenger is completed when a predetermined period of time passes after the passenger gets off the vehicle at the final get-off point.

Upon determining that the passenger finished getting off the vehicle, the processor 170 can transmit the passenger disembarking information to the external server 20 (S516). The passenger disembarking information can include information about the location of the get-off point at which the passenger finished getting off the vehicle, information about the time at which the passenger finished getting off the vehicle, passenger type information, and information about whether the passenger got out of the vehicle safely.

The external server 20 can receive the passenger disembarking information from the processor 170, and can store the passenger disembarking information (S517). The external server 20 can utilize the stored passenger disembarking information for disembarking of another passenger.

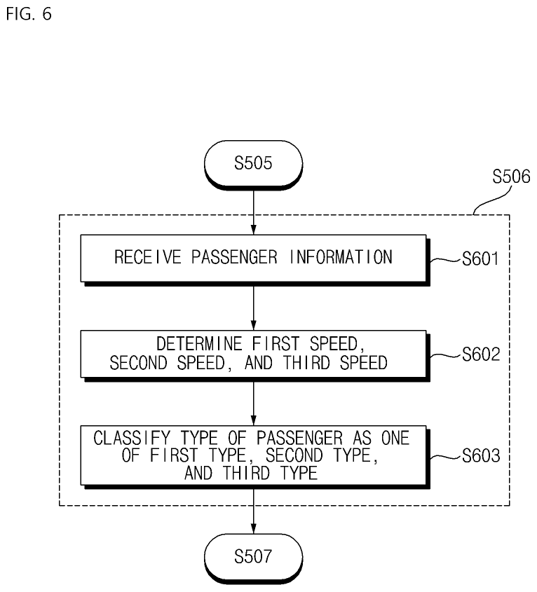

FIG. 6 is a flowchart of the step of classifying the type of passenger according to an embodiment of the present disclosure.

Referring to FIG. 6, the external server 20 can classify the type of passenger as any one of a first type, a second type, and a third type based on the passenger information. The external server 20 can classify the type of passenger as a fourth type or the like based on other classification criteria.

The external server 20 can classify the type of passenger based on the passenger information (S506). The passenger information can include passenger age information and passenger state information. The passenger state information can include information about the state of the passenger, which can be identified from an image of the external appearance of the passenger that is acquired through the camera, for example, information about whether the passenger is pregnant, whether the passenger is using a mobility assistance device, whether the passenger is using a mobile terminal, whether the passenger is carrying baggage, or the like.

The external server 20 can receive passenger information from the processor 170 (S601).

The external server 20 can classify the type of passenger based on a first speed, which is the speed at which the passenger gets off the vehicle, a second speed, which is the speed at which the passenger moves after getting off the vehicle, and a third speed, which is the speed at which the passenger responds to an emergency situation. The type of passenger can be any one of a first type, a second type, and a third type.

The external server 20 can determine whether the first speed, the second speed, and the third speed are within respective predetermined ranges based on the passenger information (S602). The external server 20 can classify the type of passenger into the first type, the second type, and the third type based on the first speed, the second speed, and the third speed (S603).

When all of the first speed, the second speed, and the third speed are within respective predetermined ranges, the external server 20 can classify the type of passenger as the first type. When any one of the first speed, the second speed, and the third speed is within a predetermined range or when any one of the first speed, the second speed, and the third speed is out of a predetermined range, the external server 20 can classify the type of passenger as the second type. When all of the first speed, the second speed, and the third speed are out of respective predetermined ranges, the external server 20 can classify the type of passenger as the third type.

The first type can be a safe type. The safe type can be a type of passenger who is capable of perceiving a disembarking situation and rapidly and safely responding to an emergency situation. For example, the external server 20 can classify passengers, who are adults in their twenties to fifties, are not using mobility assistance devices, and are not performing any behavior other than getting off the vehicle, as the safe type.

The second type can be an attention-requiring type. The attention-requiring type can be a type of passenger who requires a certain amount of time to perceive a disembarking situation and to respond to an emergency situation. For example, the external server 20 can classify the elderly, pregnant women, the disabled, mobility assistance device users, passengers who are performing other behaviors (e.g. using their mobile terminals) while getting off the vehicle, and passengers who are carrying baggage while getting off the vehicle, as the attention-requiring type.

The third type can be a sensitive type. The sensitive type can be a type of passenger who is incapable of perceiving a disembarking situation or responding to an emergency situation. For example, the external server 20 can classify children, the elderly and the infirm in the older age group, and passengers who, for whatever reason, have greater mobility difficulties than the attention-requiring type of passengers, as the sensitive type.

The type of passenger can be classified in consideration of the passenger state information as well as the passenger age information. For example, if an adult is on the phone while getting off the vehicle, the type of passenger can be changed from the first type to the second type. For example, if an elderly person with baggage is getting off the vehicle, the type of passenger can be changed from the second type to the third type.

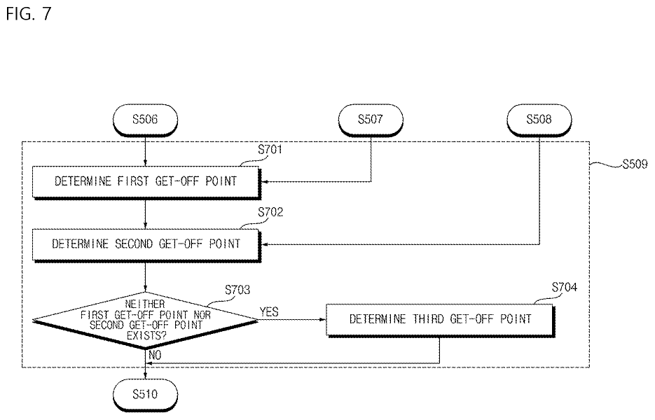

FIG. 7 is a flowchart of the step of determining a get-off point according to an embodiment of the present disclosure.

Referring to FIG. 7, the processor 170 can determine one or more get-off points, in consideration of destination information, based on the type of passenger (S509). The one or more get-off points can include a first get-off point, a second get-off point, and a third get-off point. The get-off point can include a fourth get-off point or the like based on other criteria.

The processor 170 can determine the first get-off point based on the passenger type information and/or the destination information (S701). The first get-off point can be an appropriate get-off point determined based on the passenger type information and/or the destination information.

The processor 170 can determine the first get-off point by receiving the passenger type information from the external server 20 and receiving the destination information through the interface unit 180.

The passenger type information can include information about whether the type of passenger corresponds to the first type, which is the safe type, the second type, which is the attention-requiring type, or the third type, which is the sensitive type. The destination information can include road condition information, traffic condition information, information about objects in the vicinity of the destination, weather information, and the like.

Destination information can be based on the passenger type information. That is, the processor 170 may receive passenger type information from the external server 20 and receive destination information based on the passenger type information.

The processor 170 may selectively obtain destination information to be acquired according to the passenger type by considering the passenger type information in advance.

In the case of the first type, the processor 170 may consider the destination information to a minimum. In the case of the second type, the processor 170 may consider the destination information more than the case of the first type. In the case of the third type, the processor 170 may consider the destination information the same as or more than that of the second type.

In this way, by obtaining destination information based on the type of passenger, it is possible to obtain necessary and concentrated information. In addition, it is possible to quickly determine the point of getting off, and minimize traffic congestion due to getting off of the passenger.

For example, in the case of the first type, the first get-off point can include a point that is located the shortest distance from the destination. Upon determining that the passenger is a general adult in his/her twenties, the processor 170 can determine the point closest to the destination to be the first get-off point. In this case, the road conditions or the traffic conditions in the vicinity of the destination can be taken into consideration.

For example, in the case of the second type, the first get-off point can include a point at which the number of obstacles or the amount of traffic is small and the road conditions are good. Upon determining that the passenger is a pregnant woman or a person who is using a mobility assistance device (e.g. a cane or a wheelchair), the processor 170 can determine one of a point at which there are few moving objects, a point at which there are few obstacles, and a point at which damage to road surfaces is small to be the first get-off point.

The point at which there are few moving objects can include a point of an alley, a point of a one-way street, a point in an area in which there are few pedestrians, and the like. The point at which there are few obstacles can include a point in an area in which there is no banner, a point in an area in which there is no fence on the road, and the like. The point at which damage to road surfaces is small can include a point at which the road is flat.

For example, in the case of the third type, the first get-off point can include a point at which there are few moving objects, a point that is close to a walking zone, a point of a restricted speed area, and the like. Upon determining that the passenger is a child, the processor 170 can determine a point in an area that is close to a walking zone or a sidewalk to be the first get-off point.

It is possible to determine a get-off point suitable for the type of passenger and to reduce the risk of a secondary accident by determining the first get-off point based on the passenger type information and/or the destination information.

The processor 170 can determine a second get-off point, which is a get-off point of another passenger, who is of the same type as the passenger (S702).

The processor 170 can receive information about disembarking of another passenger, who is of the same type as the passenger, from the external server 20, and can determine a second get-off point. The information about disembarking of another passenger can include information about the location of the get-off point at which the other passenger finished getting off the vehicle, information about the time at which the other passenger finished getting off the vehicle, and information about the number of times of disembarking.

The processor 170 can determine whether neither the first get-off point nor the second get-off point exists (S703). Upon determining that neither the first get-off point nor the second get-off point exists, the processor 170 can determine a third get-off point, which is a new get-off point, based on information about traffic in the vicinity of the destination (S704).

The processor 170 can determine a point in an area in which the current amount of traffic is small to be a third get-off point based on information about traffic in the vicinity of the destination. Upon determining the third get-off point, the processor 170 can transmit information about scheduled disembarking to vehicles that will pass by the third get-off point via V2X communication.

Since the information about the third get-off point is transmitted to other vehicles in advance via V2X communication only when neither the first get-off point nor the second get-off point exists, it is possible to secure the driving efficiency of the other vehicles and to reduce the wasteful use of resources of the host vehicle.

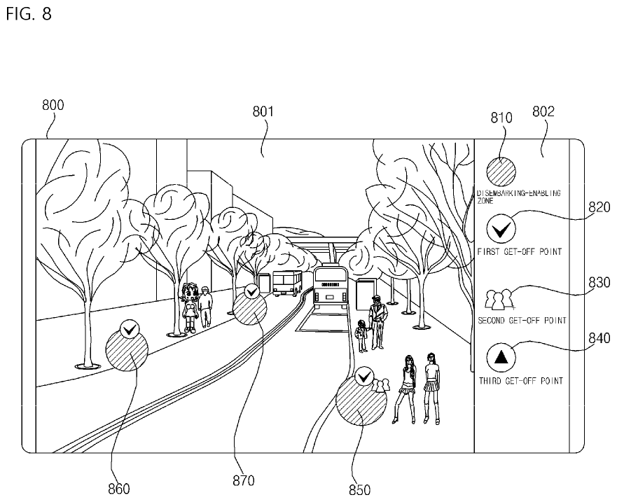

FIG. 8 is a view showing a get-off point guidance UI according to an embodiment of the present disclosure.

Referring to FIG. 8, the user interface device 200 can include a display unit 800. The vehicle 10 can communicate with a user using input and output signals through the display unit.

The display unit 800 can include a first portion 801, which displays an image captured by a camera mounted on the exterior of the vehicle 10, and a second portion 802, which displays an icon for a get-off point. The display unit 800 can display graphic objects corresponding to various pieces of information.

The first portion 801 can display an image ahead of the vehicle captured by the camera when entering an area in the vicinity of the destination. The second portion 802 can display icons, each representing a corresponding one of a disembarking-enabling zone 810, a first get-off point 820, a second get-off point 830, and a third get-off point 830. In this case, the respective icons can be displayed on the first portion 801 using augmented reality.

The vehicle 10 can determine a disembarking-enabling zone based on the destination information. Referring to FIG. 8, the vehicle 10 can determine one or more safe disembarking-enabling zones using information about traffic conditions and objects in the vicinity of the destination based on the destination information.

The vehicle 10 can display one or more safe disembarking zones on the display unit 800. In this case, the one or more safe disembarking zones can be displayed on the first portion 801 through augmented reality.

According to an embodiment of the present disclosure, the safe disembarking zone can include a first zone 850, a second zone 860, and a third zone 870.

The vehicle 10 can determine whether at least one of the first get-off point, the second get-off point, or the third get-off point is included in the safe disembarking zone. If at least one of the first get-off point, the second get-off point, or the third get-off point is included in the safe disembarking zone, the vehicle 10 can display icons, which respectively correspond to the first get-off point 820, the second get-off point 830, and the third get-off point 840, in the safe disembarking zone.

Referring to FIG. 8, the first zone 850, which is the safe disembarking zone, can include the first get-off point 820 and the second get-off point 830. The second zone 860 can include the first get-off point 820. The third zone 870 can include the first get-off point 820.

According to an embodiment of the present disclosure, in the case of the second type of passenger, the vehicle 10 can determine a point in an area in which the amount of traffic is small, no obstacle exists, and the road conditions are good to be the first get-off point. In addition, the vehicle 10 can display the second get-off point, which is the get-off point of another passenger, who is of the second type. The user can select any one get-off point from among the one or more get-off points.

Although not shown in the drawings, when neither the first get-off point nor the second get-off point exists, the third get-off point can be displayed on the display unit 800 through an icon corresponding to the third get-off point 840.

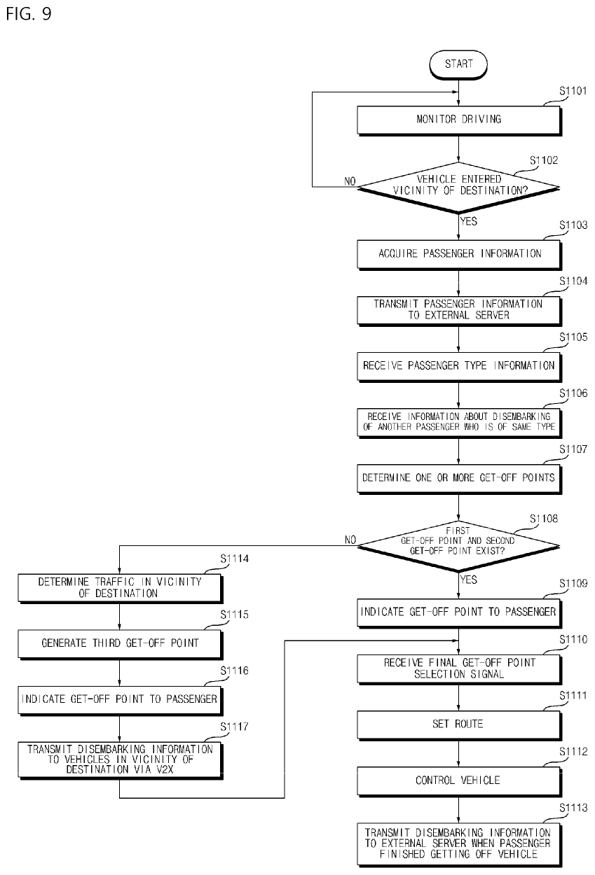

FIG. 9 is a flowchart of a processor according to an embodiment of the present disclosure.

Referring to FIG. 9, the processor 170 can start monitoring driving while the vehicle travels to the destination according to a destination input signal (S1101). The processor 170 can determine whether the vehicle has entered the vicinity of the destination through driving monitoring (S1102).

The processor 170 can acquire passenger information through the internal or external camera of the vehicle (S1103), and can transmit the passenger information to the external server 20 (S1104). The processor 170 can receive passenger type information from the external server 20 (S1105), and can receive information about disembarking of another passenger who is of the same type (S1106).

The processor 170 can determine one or more get-off points including the first get-off point or the second get-off point (S1107). The processor 170 can determine whether the first get-off point and the second get-off point exist (S1108). If the get-off points exist, the processor 170 can indicate the get-off points to the passenger through the UI (S1109).

Upon determining that neither the first get-off point nor the second get-off point exists, the processor 170 can determine the amount of traffic in the vicinity of the destination (S1114), and can generate a third get-off point (S1115). The processor 170 can indicate the third get-off point to the passenger (S1116), and can transmit information about scheduled disembarking to vehicles in the vicinity of the destination via V2X communication (S1117).

The get-off point guidance can be performed through audio guidance as well as visual guidance through the display unit 800. According to an embodiment of the present disclosure, when the third get-off point is generated, audio guidance can be performed as follows: “No safe zone is found in the vicinity of the destination. So, generation of a safe zone is necessary.”

In addition, the vehicle 10 can find an area in which the current amount of traffic is small through the camera, and can transmit information about scheduled disembarking to vehicles that will pass by the corresponding point in the found area. The information about scheduled disembarking can include information about the location of the get-off point and disembarking time information. Upon finishing generating the get-off point, the vehicle 10 can perform audio guidance as follows: “A safe zone for the passenger has been generated. Information about the safe zone generation has been transmitted to other vehicles. Don't worry.”

The processor 170 can select a final get-off point through a signal input by the user (S1110), can set a route to the final get-off point (S1111), and can control driving of the vehicle based on the set route (S1112).

Upon determining that the passenger finished getting off the vehicle, the processor 170 can transmit disembarking information to the external server 20. The disembarking information can include passenger type information, information about the location of the get-off point, disembarking time information, and information about whether the passenger got out of the vehicle safely.

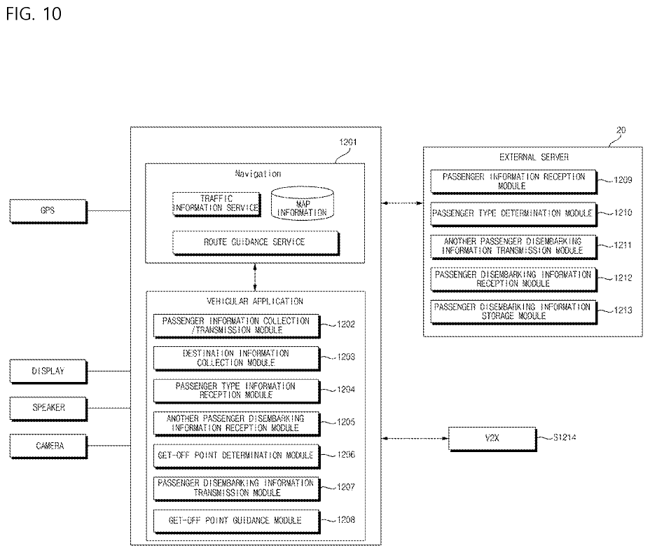

FIG. 10 is a diagram showing a get-off point guidance system according to an embodiment of the present disclosure.

Referring to FIG. 10, a get-off point guidance system can include a vehicular application, a navigation system, an external server, a GPS, a display, a speaker, a camera, and a V2X communication unit.

The navigation system 1201 can acquire location information of the vehicle 10 through the GPS, and can provide a route guidance service based on traffic information and map information.

The vehicular application can be electronically connected to the navigation system 1201, and can include a passenger information collection/transmission module 1202, a destination information collection module 1203, a passenger type information reception module 1204, an another passenger disembarking information reception module 1205, a get-off point determination module 1206, a passenger disembarking information transmission module 1207, and a get-off point guidance module 1208.

The passenger information collection/transmission module 1202 can collect passenger age information and passenger state information through the camera, and can transmit the collected passenger information to the external server 20.

The destination information collection module 1203 can collect information about traffic conditions, road conditions, objects, and weather in the vicinity of the destination through the object detection device and the communication device.

The passenger type information reception module 1204 can receive information about the type of passenger determined by the external server 20.

The another passenger disembarking information reception module 1205 can receive information about disembarking of another passenger, who is of the same type as the type of passenger determined by the external server 20.

The get-off point determination module 1206 can determine a first get-off point, a second get-off point, and a third get-off point based on the passenger type information and/or the destination information.

When the passenger finishes getting off the vehicle at the final get-off point, the passenger disembarking information transmission module 1207 can transmit, to the external server 20, disembarking information including information about the location of the final get-off point, disembarking time information, passenger type information, and information about whether the passenger got out of the vehicle safely.

The get-off point guidance module 1208 can display and indicate one or more get-off points through the user interface device. The get-off points can be displayed such that icons, each of which represents a corresponding one of the first get-off point, the second get-off point, and the third get-off point, are displayed on an image captured by the camera through augmented reality.

The vehicular application can communicate with external devices via V2X communication. The vehicular application can communicate with the external server 20 through the communication device. The communication with the external server or the external devices can be realized using 5G communication.

The external server 20 can include a passenger information reception module 1209, a passenger type determination module 1210, an another passenger disembarking information transmission module 1211, a passenger disembarking information reception module 1212, and a passenger disembarking information storage module 1213.

The passenger information reception module 1209 can receive passenger information from the passenger information transmission module 1202.

The passenger type determination module 1210 can determine a first speed, which is the speed at which the passenger gets off the vehicle, a second speed, which is the speed at which the passenger moves after getting off the vehicle, and a third speed, which is the speed at which the passenger responds to an emergency situation, based on the received passenger information. In addition, the passenger type determination module 1210 can determine and classify the type of passenger as one of a first type, a second type, and a third type based on the first speed, the second speed, and the third speed.

The another passenger disembarking information transmission module 1211 can transmit information about disembarking of another passenger, who is of the same type as the passenger, to the another passenger disembarking information reception module 1205 in the vicinity of the destination.

The passenger disembarking information reception module 1212 can receive disembarking information when the passenger finishes getting off the vehicle.

The passenger disembarking information storage module 1213 can store the passenger disembarking information received from the passenger disembarking information transmission module 1207. The stored passenger disembarking information can be used for disembarking of another passenger.

FIG. 11 illustrates an example of the basic operation of an autonomous vehicle and a 5G network in a 5G communication system.

The autonomous vehicle 10 transmits specific information to the 5G network (S1).

The specific information can include autonomous-driving-related information.

The autonomous-driving-related information can be information directly related to control of driving of the vehicle 10. For example, the autonomous-driving-related information can include at least one of object data indicating an object around the vehicle, map data, vehicle state data, vehicle location data, or driving plan data.

The autonomous-driving-related information can further include service information required for autonomous driving and the like. For example, the service information can include information about a destination input through a user terminal and information about the safety grade of the vehicle 10. In addition, the 5G network can determine whether remote control of the vehicle 10 is executed (S2).

In this case, the 5G network can include a server or a module for executing remote control associated with autonomous driving.

In addition, the 5G network can transmit information (or a signal) associated with remote control to the autonomous vehicle (S3).

As described above, the information associated with the remote control can be a signal directly applied to the autonomous vehicle 10, and can further include service information required for autonomous driving. In an embodiment of the present disclosure, the autonomous vehicle 10 can provide services associated with autonomous driving by receiving service information such as information about section-based insurance and a dangerous section selected on a travel path through a server connected to the 5G network.

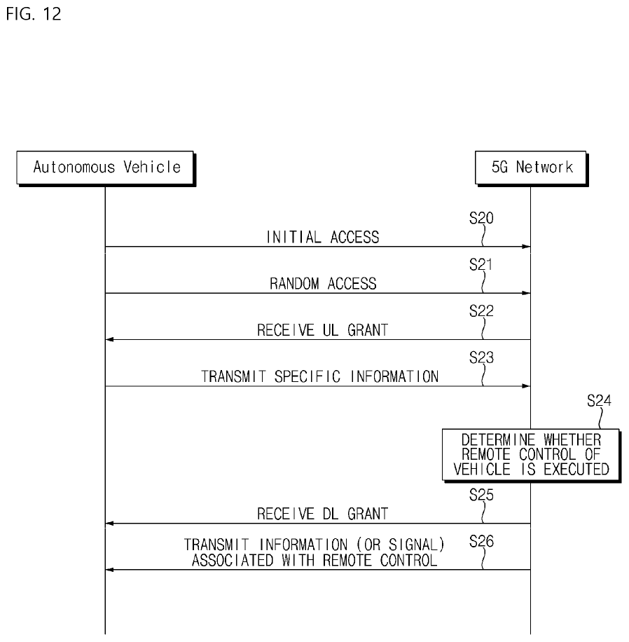

Hereinafter, essential processes for 5G communication between the autonomous vehicle 10 and the 5G network (e.g. a process of initial access between the vehicle and the 5G network, etc.) will be briefly described with reference to FIGS. 12 to 16, in order to provide insurance service applicable on a section basis in the autonomous driving process in accordance with an embodiment of the present disclosure.

FIG. 12 illustrates an example of the application operation of the autonomous vehicle 10 and the 5G network in the 5G communication system.

The autonomous vehicle 10 performs a process of initial access to the 5G network (S20).

The initial access process includes a cell search process for acquiring a downlink (DL) operation, a process for acquiring system information, etc.

In addition, the autonomous vehicle 10 performs a process of random access to the 5G network (S21).

The random access process includes a preamble transmission process for uplink (UL) synchronization acquisition or UL data transmission, a random access response reception process, etc.

In addition, the 5G network transmits, to the autonomous vehicle 10, a UL grant for scheduling transmission of specific information (S22).

The UL grant reception can include a process of receiving time/frequency resource scheduling in order to transmit UL data to the 5G network.

In addition, the autonomous vehicle 10 transmits specific information to the 5G network based on the UL grant (S23).

The 5G network then determines whether remote control of the vehicle 10 is executed (S24).

The autonomous vehicle 10 then receives a DL grant through a physical downlink control channel in order to receive a response to the specific information from the 5G network (S25).

The 5G network then transmits information (or a signal) associated with remote control to the autonomous vehicle 10 based on the DL grant (S26).

Meanwhile, although an example in which the processes of initial access and random access of the autonomous vehicle 10 to the 5G communication network and the process of receiving a DL grant are combined has been illustratively described with reference to FIG. 12 through steps S20 to S26, the present disclosure is not limited thereto.

For example, the initial access process and/or the random access process can be executed through steps S20, S22, S23, S24, and S26. For example, the initial access process and/or the random access process can be executed through steps S21, S22, S23, S24, and S26. In addition, a process of combining the AI operation and the downlink grant reception process can be executed through steps S23, S24, S25, and S26.

In addition, although the operation of the autonomous vehicle 10 has been illustratively described with reference to FIG. 12 through steps S20 to S26, the present disclosure is not limited thereto.

For example, the operation of the autonomous vehicle 10 can be performed through selective combination of steps S20, S21, S22, and S25 with steps S23 and S26. For example, the operation of the autonomous vehicle 10 can be constituted by steps S21, S22, S23, and S26. For example, the operation of the autonomous vehicle 10 can be constituted by steps S20, S21, S23, and S26. In addition, for example, the operation of the autonomous vehicle 10 can be constituted by steps S22, S23, S25, and S26.

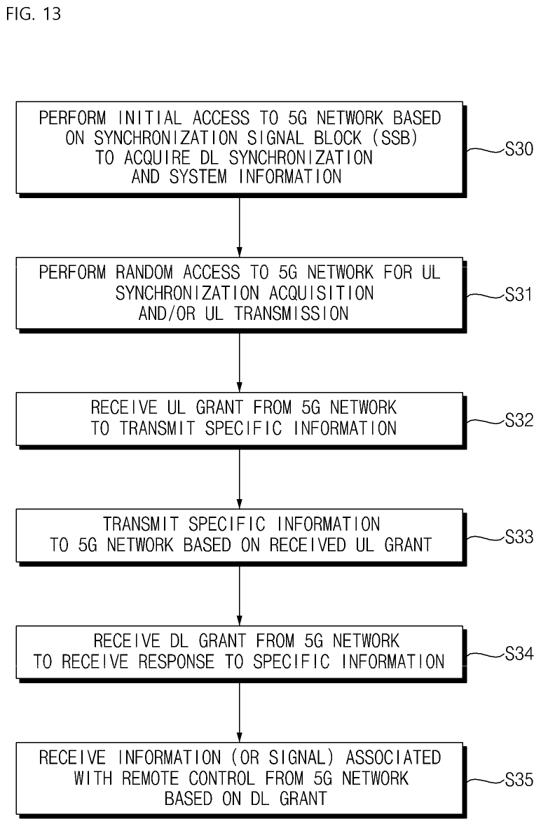

FIGS. 13 to 16 illustrate an example of the operation of the autonomous vehicle 10 using the 5G communication.

First, referring to FIG. 13, the autonomous vehicle 10, which includes an autonomous driving module, performs a process of initial access to the 5G network based on a synchronization signal block (SSB) in order to acquire DL synchronization and system information (S30).

In addition, the autonomous vehicle 10 performs a process of random access to the 5G network in order to realize UL synchronization acquisition and/or UL transmission (S31).

In addition, the autonomous vehicle 10 receives a UL grant from the 5G network in order to transmit specific information (S32).

In addition, the autonomous vehicle 10 transmits the specific information to the 5G network based on the UL grant (S33).

In addition, the autonomous vehicle 10 receives a DL grant from the 5G network in order to receive a response to the specific information (S34).

In addition, the autonomous vehicle 10 receives information (or a signal) associated with remote control from the 5G network based on the DL grant (S35).

A beam management (BM) process can be added to step S30. A beam failure recovery process associated with transmission of a physical random access channel (PRACH) can be added to step S31. A quasi-co-location (QCL) relationship can be added to step S32 in association with a beam reception direction of a physical downlink control channel (PDCCH) including a UL grant. A QCL relationship can be added to step S33 in association with a beam transmission direction of a physical uplink control channel (PUCCH)/physical uplink shared channel (PUSCH) including specific information. In addition, a QCL relationship can be added to step S34 in association with a beam reception direction of a PDCCH including a DL grant.

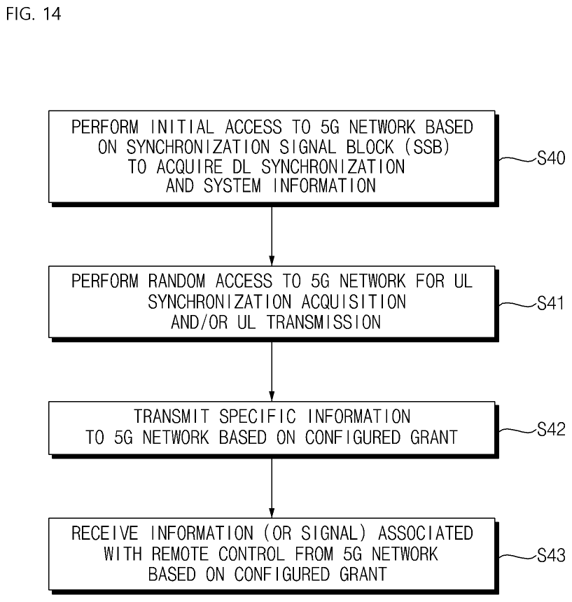

Referring to FIG. 14, the autonomous vehicle 10 performs a process of initial access to the 5G network based on an SSB in order to acquire DL synchronization and system information (S40).

In addition, the autonomous vehicle 10 performs a process of random access to the 5G network in order to realize UL synchronization acquisition and/or UL transmission (S41).

In addition, the autonomous vehicle 10 transmits specific information to the 5G network based on a configured grant (S42). Transmission of the specific information based on the configured grant can be carried out in place of the process of receiving the UL grant from the 5G network.

In addition, the autonomous vehicle 10 receives information (or a signal) associated with remote control from the 5G network based on the configured grant (S43).

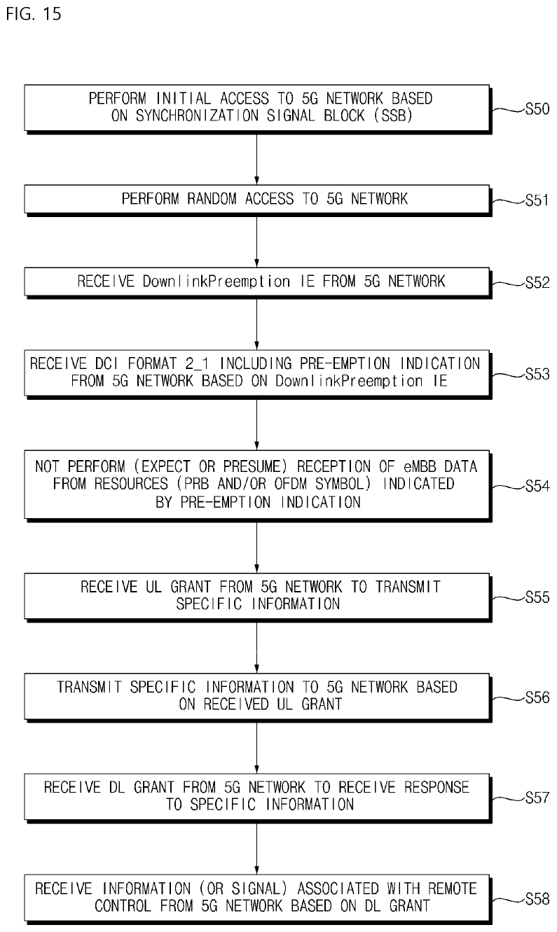

Referring to FIG. 15, the autonomous vehicle 10 performs a process of initial access to the 5G network based on an SSB in order to acquire DL synchronization and system information (S50).

In addition, the autonomous vehicle 10 performs a process of random access to the 5G network in order to realize UL synchronization acquisition and/or UL transmission (S51).

In addition, the autonomous vehicle 10 receives a DownlinkPreemption IE from the 5G network (S52).

In addition, the autonomous vehicle 10 receives a downlink control information (DCI) format 2_1 including a preemption indication from the 5G network based on the DownlinkPreemption IE (S53).

In addition, the autonomous vehicle 10 does not perform (expect or presume) reception of enhanced mobile broadband (eMBB) data from resources (physical resource block (PRB) symbols and/or orthogonal frequency division multiplexing (OFDM) symbols) indicated by the pre-emption indication (S54).

In addition, the autonomous vehicle 10 receives a UL grant from the 5G network in order to transmit specific information (S55).

In addition, the autonomous vehicle 10 transmits the specific information to the 5G network based on the UL grant (S56).

In addition, the autonomous vehicle 10 receives a DL grant from the 5G network in order to receive a response to the specific information (S57).

In addition, the autonomous vehicle 10 receives information (or a signal) associated with remote control from the 5G network based on the DL grant (S58).

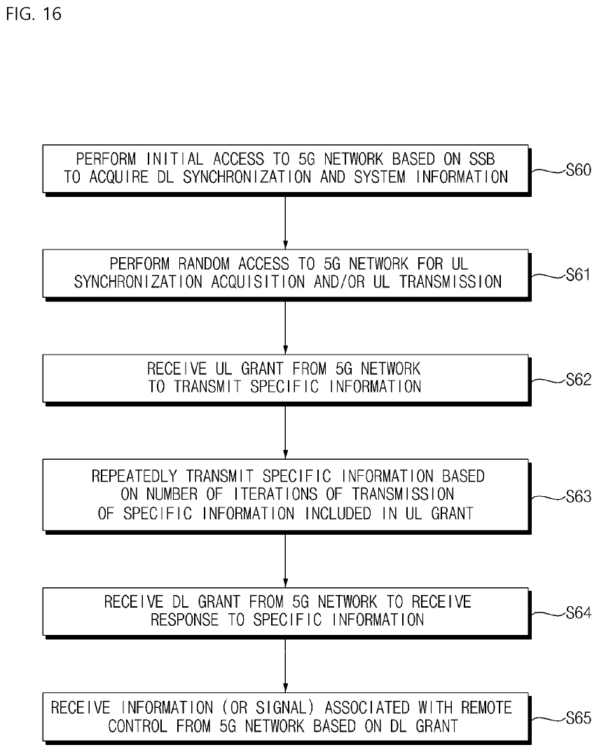

Referring to FIG. 16, the autonomous vehicle 10 performs a process of initial access to the 5G network based on an SSB in order to acquire DL synchronization and system information (S60).

In addition, the autonomous vehicle 10 performs a process of random access to the 5G network in order to realize UL synchronization acquisition and/or UL transmission (S61).

In addition, the autonomous vehicle 10 receives a UL grant from the 5G network in order to transmit specific information (S62).

The UL grant includes information about the number of iterations of transmission of the specific information. The specific information is repeatedly transmitted based on the information about the number of iterations (S63).

In addition, the autonomous vehicle 10 transmits the specific information to the 5G network based on the UL grant.

In addition, repeated transmission of specific information is carried out through frequency hopping. Transmission of first specific information can be achieved through a first frequency resource, and transmission of second specific information can be achieved through a second frequency resource.

The specific information can be transmitted through a narrow band of 6RB (Resource Block) or 1RB (Resource Block). In addition, the autonomous vehicle 10 receives a DL grant from the 5G network in order to receive a response to the specific information (S64).

In addition, the autonomous vehicle 10 receives information (or a signal) associated with remote control from the 5G network based on the DL grant (S65).

The above-described 5G communication technology can be applied in the state of being combined with the methods proposed in the present disclosure and described with reference to FIGS. 1 to 10, or can be supplemented to concretize or clarify technical features of the methods proposed in the present disclosure.

The vehicle 10 disclosed in the present disclosure is connected to an external server through a communication network, and is movable along a predetermined route using autonomous driving technology without the intervention of a driver. The vehicle 10 of the present disclosure can be any of an internal combustion vehicle equipped with an engine as a power source, a hybrid vehicle equipped with an engine and an electric motor as power sources, an electric vehicle equipped with an electric motor as a power source, and the like.

In the following embodiment, the user can be interpreted as a driver, a passenger, or a possessor of a user terminal. The user terminal can be a mobile terminal carried by the user to execute telephone communication and various applications, for example, a smartphone, without being limited thereto. For example, the user terminal can be interpreted as a mobile terminal, a personal computer (PC), a laptop computer, or an autonomous vehicle system.

In the autonomous vehicle 10, the type and frequency of occurrence of accidents can vary greatly in accordance with the ability to sense surrounding dangerous factors in real time. The route to a destination can include sections having different danger levels in accordance with various causes such as weather, topographical features, traffic congestion, etc. According to the present disclosure, insurance needed on a section basis is informed when a destination is input by the user, and insurance information is updated in real time through monitoring of dangerous sections.

At least one of the autonomous vehicle 10 of the present disclosure, a user terminal, or a server can be linked to or combined with an artificial intelligence module, a drone (unmanned aerial vehicle (UAV)), a robot, an augmented reality (AR) device, a virtual reality (VR) device, a device associated with a 5G service, etc.

For example, the autonomous vehicle 10 can operate in linkage with at least one artificial intelligence module included in the vehicle 10 and with a robot.

For example, the vehicle 10 can co-operate with at least one robot. The robot can be an autonomous mobile robot (AMR) that is autonomously movable. The mobile robot is configured to be autonomously movable, and as such is freely movable. The mobile robot can be provided with a plurality of sensors to enable the mobile robot to bypass an obstacle during travel, and as such can travel while bypassing obstacles. The mobile robot can be a flying-type robot (e.g. a drone) including a flying device. The mobile robot can be a wheeled robot including at least one wheel, and can move through rotation of the wheel. The mobile robot can be a leg-type robot including at least one leg, and can move using the leg.

The robot can function as an apparatus for increasing the convenience of the user of the vehicle. For example, the robot can perform a function of transporting a load carried in the vehicle 10 to a user's final destination. For example, the robot can perform a function of guiding a way to a final destination to a user who has exited the vehicle 10. For example, the robot can perform a function of transporting the user having exited the vehicle 10 to a final destination.

At least one electronic device included in the vehicle 10 can communicate with the robot through the communication device 220.

At least one electronic device included in the vehicle 10 can provide, to the robot, data processed in at least one electronic device included in the vehicle 10. For example, at least one electronic device included in the vehicle 10 can provide, to the robot, at least one of object data indicating an object around the vehicle 10, map data, data on the state of the vehicle 10, data on the location of the vehicle 10, or driving plan data.

At least one electronic device included in the vehicle 10 can receive, from the robot, data processed in the robot. At least one electronic device included in the vehicle 10 can receive at least one of sensing data generated in the robot, object data, robot state data, robot location data, or robot movement plan data.

At least one electronic device included in the vehicle 10 can generate a control signal based further on data received from the robot. For example, at least one electronic device included in the vehicle 10 can compare information about an object generated in an object detection device with information about an object generated by the robot, and can generate a control signal based on the comparison result. At least one electronic device included in the vehicle 10 can generate a control signal in order to prevent interference between a travel path of the vehicle 10 and a travel path of the robot.

At least one electronic device included in the vehicle 10 can include a software module or a hardware module (hereinafter, an artificial intelligence (AI) module) realizing artificial intelligence. At least one electronic device included in the vehicle 10 can input acquired data to the artificial intelligence module, and can use data output from the artificial intelligence module.

The artificial intelligence module can execute machine learning of input data using at least one artificial neural network (ANN). The artificial intelligence module can output driving plan data through machine learning of input data.

At least one electronic device included in the vehicle 10 can generate a control signal based on data output from the artificial intelligence module.

In some embodiments, at least one electronic device included in the vehicle 10 can receive data processed through artificial intelligence from an external device via the communication device 220. At least one electronic device included in the vehicle 10 can generate a control signal based on data processed through artificial intelligence.

The aforementioned present disclosure can be implemented as computer-readable code stored on a computer-readable recording medium. The computer-readable recording medium can be any type of recording device in which data is stored in a computer-readable manner. Examples of the computer-readable recording medium include a Hard Disk Drive (HDD), a Solid-State Disk (SSD), a Silicon Disk Drive (SDD), Read-Only Memory (ROM), Random-Access Memory (RAM), CD-ROM, magnetic tapes, floppy disks, optical data storage devices, carrier waves (e.g. transmission via the Internet), etc. In addition, the computer can include a processor and a controller. The above embodiments are therefore to be construed in all aspects as illustrative and not restrictive. It is intended that the present disclosure cover the modifications and variations of this disclosure provided they come within the scope of the appended claims and their equivalents.

### DESCRIPTION OF REFERENCE NUMERALS

10: vehicle
20: external server
100: electronic device
140: memory
170: processor
180: interface unit
190: power supply unit
S501: input destination
S502: set destination
S503: determine whether vehicle is located in vicinity of destination
S504: acquire passenger information
S505: transmit passenger information
S506: classify type of passenger
S507: transmit passenger type information
S508: transmit another passenger disembarking information
S509: determine one or more get-off points
S510: guide one or more get-off points
S511: select final get-off point
S512: set final get-off point
S513: generate route
S514: control vehicle
S515: determine whether disembarking is finished
S516: transmit passenger disembarking information
S517: store passenger disembarking information

What is claimed is:

1. A method for guiding a get-off point, comprising:
acquiring, by a processor, passenger information through a camera;
classifying, by an external server, a type of passenger based on the passenger information;
determining, by the processor, one or more get-off points based on the type of passenger; and
indicating, by the processor, the one or more get-off points to the passenger.

2. The method of claim 1, wherein the acquiring passenger information comprises:
receiving, by the processor, location information of a vehicle;
determining, by the processor, whether the vehicle is located within a predetermined distance from the destination based on the location information, and
acquiring, by the processor, upon determining that the vehicle is located within a predetermined distance from the destination, the passenger information through the camera.

3. The method of claim 2, wherein the passenger information comprises age information of the passenger and state information of the passenger, the age information of the passenger and the state information of the passenger being acquired from an image of the passenger captured by the camera.

4. The method of claim 3, wherein the classifying a type of passenger comprises:
receiving, by the external server, the passenger information from the processor;
determining a first speed, the first speed being a speed at which the passenger gets off the vehicle, a second speed, the second speed being a speed at which the passenger moves after getting off the vehicle, and a third speed, the third speed being a speed at which the passenger responds to an emergency situation, based on the passenger information; and
classifying the type of passenger as one of a first type, a second type, and a third type based on the first speed, the second speed, and the third speed.

5. The method of claim 4, wherein, when the first speed, the second speed, and the third speed, determined based on the passenger information, are within respective predetermined ranges, the external server classifies the type of passenger as the first type.

6. The method of claim 4, wherein, when any one of the first speed, the second speed, and the third speed, determined based on the passenger information, is within a predetermined range or when any one of the first speed, the second speed, and the third speed, determined based on the passenger information, is out of a predetermined range, the external server classifies the type of passenger as the second type.

7. The method of claim 4, wherein, when the first speed, the second speed, and the third speed, determined based on the passenger information, are out of respective predetermined ranges, the external server classifies the type of passenger as the third type.

8. The method of claim 1, wherein the determining one or more get-off points comprises:
determining, by the processor, a first get-off point based on passenger type information and/or a destination information; and
determining, by the processor, a second get-off point, the second get-off point being a get-off point of another passenger who is of a same type as the type of passenger.

9. The method of claim 8, wherein the determining a first get-off point comprises:
receiving, by the processor, the passenger type information from the external server; and
receiving, by the processor, the destination information through an interface, and
wherein the destination information comprises at least one of road condition information, traffic condition information, information about objects in vicinity of a destination, or weather information.

10. The method of claim 8, wherein the determining a second get-off point comprises:
receiving, by the processor, disembarking information of another passenger, who is of a same type as the type of passenger, from the external server, and
wherein the disembarking information of another passenger comprises information about a location of a get-off point at which the another passenger finished getting off a vehicle and information about a number of times of disembarking.

11. The method of claim 8, wherein the determining one or more get-off points further comprises:
generating, by the processor, upon determining that neither the first get-off point nor the second get-off point exists, a third get-off point based on information about traffic in vicinity of the destination, the third get-off point being a new get-off point.

12. The method of claim 11, wherein the indicating the one or more get-off points comprises:
outputting, by the processor, information about locations of the one or more get-off points through a user interface device; and
determining, by the processor, one final get-off point among the one or more get-off points based on a signal input by the passenger.

13. The method of claim 12, wherein the one or more get-off points comprise at least one of the first get-off point, the second get-off point, or the third get-off point, and
wherein the outputting information about locations of the one or more get-off points comprises displaying, by the processor, different icons, each representing a corresponding one of the first get-off point, the second get-off point, and the third get-off point, at corresponding locations.

14. The method of claim 12, wherein the indicating the one or more get-off points further comprises:
transmitting, by the processor, upon determining that the third get-off point is the final get-off point, information about get-off to vehicles in vicinity of the third get-off point via V2X communication.

15. The method of claim 1, further comprising:
determining, by the processor, whether the passenger finished getting off a vehicle;
transmitting, by the processor, upon determining that the passenger finished getting off the vehicle, disembarking information of the passenger to the external server; and
storing, by the external server, the disembarking information of the passenger, and
wherein the disembarking information of the passenger comprises information about a location of a get-off point at which the passenger finished getting off the vehicle, disembarking time information, information about the type of passenger, and information about whether the passenger got out of the vehicle safely.

16. A vehicular electronic device, comprising:
a processor configured to:
upon determining that a vehicle is located within a predetermined distance from an input destination, acquire passenger information through a camera,
receive, from an external server, information about a type of passenger classified based on the passenger information,
determine one or more get-off points, in consideration of destination information, based on the type of passenger, and
output the one or more get-off points to the passenger through a user interface device.

17. The vehicular electronic device of claim 16, wherein the external server is configured to:
receive the passenger information from the processor, and
determine a first speed, the first speed being a speed at which the passenger gets off the vehicle, a second speed, the second speed being a speed at which the passenger moves after getting off the vehicle, and a third speed, the third speed being a speed at which the passenger responds to an emergency situation, based on the passenger information, and
wherein the information about the type of passenger is information about any one of a first type, a second type, and a third type, classified based on the first speed, the second speed, and the third speed.

18. The vehicular electronic device of claim 17, wherein the processor is configured to:
determine a first get-off point based on the information about the type of passenger and the destination information,
determine a second get-off point, the second get-off point being a get-off point of another passenger who is of a same type as the type of passenger, and
upon determining that neither the first get-off point nor the second get-off point exists, generate a third get-off point based on information about traffic in vicinity of the destination, the third get-off point being a new get-off point.

19. The vehicular electronic device of claim 18, wherein the processor is configured to:
determine one final get-off point among the one or more get-off points based on a signal input by the passenger,
generate a route based on the final get-off point,
control driving of the vehicle based on the generated route, and
when the third get-off point is the final get-off point, transmit information about get-off to vehicles in vicinity of the third get-off point via V2X communication.

20. The vehicular electronic device of claim 19, wherein the processor is configured to transmit, upon determining that the passenger finished getting off the vehicle at the final get-off point, disembarking information of the passenger to the external server, and
wherein the disembarking information of the passenger comprises information about a location of a get-off point at which the passenger finished getting off the vehicle, disembarking time information, information about the type of passenger, and information about whether the passenger got out of the vehicle safely.
